(19) United States
(12) Patent Application Publication
(10) Pub. No.: US 2012/0330724 A1
(43) Pub. Date: Dec. 27, 2012

(54) FUEL PRICING

(75) Inventor: David McCaffrey, Manchester (GB)

(73) Assignee: KNOWLEDGE SUPPORT SYSTEMS LTD., Manchester (GB)

(21) Appl. No.: 13/169,237

(22) Filed: Jun. 27, 2011

(51) Int. Cl. G06Q 30/00

(52) U.S. Cl. 705/7.35

(57) ABSTRACT

A computer-implemented method of selecting a fuel type for a retail fuel site, the method being implemented in a computer comprising a memory in communication with a processor. The method comprises receiving, as input to the processor, data indicating a relationship between fuel price and fuel sales for a plurality of fuel types and receiving, as input to the processor, data indicating a property of the retail fuel site. The data indicating a relationship between fuel price and fuel sales for each of the plurality of fuel types is processed by the processor and the data indicating a property of the retail fuel site to select the fuel type for the retail fuel site.

### TECHNICAL FIELD

The present invention relates to fuel pricing.

### BACKGROUND OF THE INVENTION

In many industries, commercial organisations have to determine prices at which their products are to be sold. Determination of such prices will need to take into account various factors. For example, a particular commercial organisation may wish to ensure that its prices are within a predetermined limit of a particular competitor's prices. Similarly, a commercial organisation may wish to ensure that a particular constraint is applied such that prices of different products sold by that organisation have a predetermined relationship with one another.

A particular industry in which prices need to be determined is the fuel industry. In particular, it is necessary to determine prices at which fuel is to be sold at retail fuel sites. The price charged by a particular retail fuel site will be determined by a number of different parameters. For example, prices charged by the retail fuel site's competitors are likely to need to be taken into account, as are prices of various other products sold by the retail fuel site. Typically, a plurality of retail fuel sites operate in a particular region, and prices charged by different retail fuel sites in a particular region will routinely need to be taken into account. Additionally, prices charged in different regions in associated retail fuel sites may also need to be taken into account.

Traditionally, prices at which retail fuel sites sell fuel have been determined by skilled analysts who have mentally collated and processed data representing various parameters which need to be taken into account. Having carried out this processing, analysts can typically determine pricing, often convening at a meeting at which a plurality of pricing analysts make various strategy decisions.

More recently, automated systems for determining retail fuel prices have been used. In these automated systems data required for determining pricing is collected and provided to a pricing system which is often located remotely from the retail site. The pricing system uses the provided data together with other information to determine information useful for optimising fuel prices at the retail site. The other information may include a desired pricing strategy such as pricing that optimises sales volumes or that optimises retail site profit. The information generated by the pricing system generally takes the form of recommended pricing for fuels that satisfies the desired pricing strategy, but may also include other useful information such as reports and predictions of competitor prices.

There remains a need for improvements in pricing systems and methods.

### SUMMARY

It is an object of the invention to provide improvements in systems and methods for fuel pricing.

According to a first aspect of the invention there is provided a computer-implemented method of selecting a fuel type for a retail fuel site, the method being implemented in a computer comprising a memory in communication with a processor. The method comprises receiving, as input to the processor, data indicating a relationship between fuel price and fuel sales for a plurality of fuel types and receiving, as input to the processor, data indicating a property of the retail fuel site. The data indicating a relationship between fuel price and fuel sales for each of the plurality of fuel types and the data indicating a property of the retail fuel site is processed, by the processor, to select the fuel type for the retail fuel site.

In this way, the fuel type is selected such that the relationship between fuel price and fuel sales associated with the fuel type complements the retail fuel site. By selecting the fuel type in such a complementary way a pricing strategy for the site, for example, can be improved by the fuel type selection.

The property may be based upon a location of the retail fuel site alternatively or additionally the property may be a property associated with a relationship between fuel price and fuel sales for the retail fuel site. For example, the retail fuel site may have an associated location that provides the retail fuel site with low competition such that fuel prices can be set relatively high. By selecting a fuel type that is relatively unaffected by high fuel prices, improved fuel sales can be achieved.

The processing may comprise determining, by the processor, a relationship between fuel price and fuel sales for said retail fuel site based upon said property and the fuel type may be selected based upon the determined relationship for the retail fuel site and the relationships for each of the plurality of fuel types.

The fuel type may be selected to achieve substantial correspondence between the relationship for the retail fuel site and the relationship for the selected fuel type. That is, where a retail fuel site has a relatively strong relationship between fuel price and fuel sales, a fuel type with a relatively strong relationship is selected, whereas where a retail fuel site has a relatively weak relationship between fuel price and fuel sales, a fuel type with a correspondingly weak relationship is selected.

The method may further comprise determining, by the processor, the data indicating a relationship between fuel price and fuel sales for each of the plurality of fuel types.

The determining may comprise, for each of the plurality of fuel types, receiving, as input to the processor, historical data for the fuel type and processing, by the processor, the historical data to determine the relationship for the fuel type. Processing the historical data to determine the relationship for the fuel type may comprise evaluating, by the processor, a Bayesian hierarchical model with respect to the historical data.

The historical data may take any convenient form. For example the historical data may be site level fuel sales or may be market share and average price data in a given region. Each of the fuel types may be a fuel brand.

According to a second aspect of the invention there is provided a computer-implemented method of generating fuel price data for a retail fuel site, the method being implemented in a computer comprising a memory in communication with a processor. The method comprises receiving, as input to the processor, data indicating a relationship between the retail fuel site and each of a plurality of competitor retail fuel sites and processing, by the processor, the received data to select at least one competitor retail fuel site of the plurality of competitor retail fuel sites. Fuel price data for the selected at least one competitor retail fuel site is received, as input to the processor, and the fuel price data for the retail fuel site is generated, by the processor, based upon the received fuel price data for the selected at least one competitor retail fuel site.

By selecting competitors on which to base the determination of fuel price data at a retail fuel site based upon a relationship between the retail fuel site and each of the competitors in this way, fuel price data is determined which takes into account the most important competitor sites for the particular retail fuel site.

The data indicating a relationship between the retail fuel site and each of a plurality of competitor retail fuel sites may indicate, for each of the competitor retail fuel sites, a relationship between fuel price at the competitor retail fuel site and sales at the retail fuel site. That is, the relationship may be a cross elasticity for the retail fuel site and the competitor retail fuel site.

Processing the received data may comprise determining a competitor retail fuel site for which the relationship between the retail fuel site is strongest. That is, fuel price data may be determined based upon the competitor retail fuel site for which prices at that competitor retail fuel site have the greatest influence upon sales at the retail fuel site.

The method may further comprise generating, by the processor, the data indicating a relationship between the retail fuel site and each of the plurality of competitor retail fuel sites. Generating the data may comprise, for each of the competitor retail fuel sites, receiving, as input to the processor, historical data for the retail fuel site and the competitor retail fuel site and processing, by the processor, the historical data to determine the relationship for the competitor retail fuel site. Processing the historical data to determine the relationship may comprise evaluating a Bayesian hierarchical model with respect to the historical data.

The historical data may take any convenient form. For example the historical data may be site level fuel sales determined over a recent time period or may be market share and average price data in a given region.

Generating the fuel price data may comprise performing, by the processor, an optimisation operation, the optimisation operation having a price differential with respect to the selected competitor retail fuel site as a constraint.

It will be appreciated that the first and second aspects of the invention can be combined.

Aspects of the invention can be implemented in any convenient form. For example computer programs may be provided to carry out the methods described herein. Such computer programs may be carried on appropriate computer readable media which term includes appropriate non-transient tangible storage devices (e.g. discs). Aspects of the invention can also be implemented by way of appropriately programmed computers and other apparatus.

### BRIEF DESCRIPTION OF THE DRAWINGS

Embodiments of the invention will now be described, by way of example, with reference to the accompanying drawings, in which:

FIG. 1 is a schematic illustration of part of a network of associated retail fuel sites in communication with a pricing system;

FIG. 2 is a schematic illustration of the pricing system of FIG. 1;

FIG. 2A is a schematic functional block diagram of part of the pricing system of FIG. 1;

FIG. 3 is a schematic illustration showing a computer associated with the pricing system of FIG. 2 in further detail;

FIG. 4 is a screen shot of a graphical user interface suitable for providing data to the data engine of FIG. 2;

FIG. 5 is a screenshot of a pricing page for displaying information to a user;

FIG. 6 is a screenshot showing data that may be displayed as part of a pricing page such as the pricing page of FIG. 5;

FIG. 7 shows part of the screenshot of FIG. 5 in more detail;

FIG. 8 is an entity diagram of a database suitable for storing and managing data to be displayed as part of the pricing page of FIG. 5;

FIG. 9 is a flowchart showing processing to generate fuel price data;

FIG. 10 is a flowchart showing processing to select a brand for a retail fuel site; and

FIG. 11 shows relationships between coefficients of a model suitable for determining retail fuel site relationships.

### DETAILED DESCRIPTION

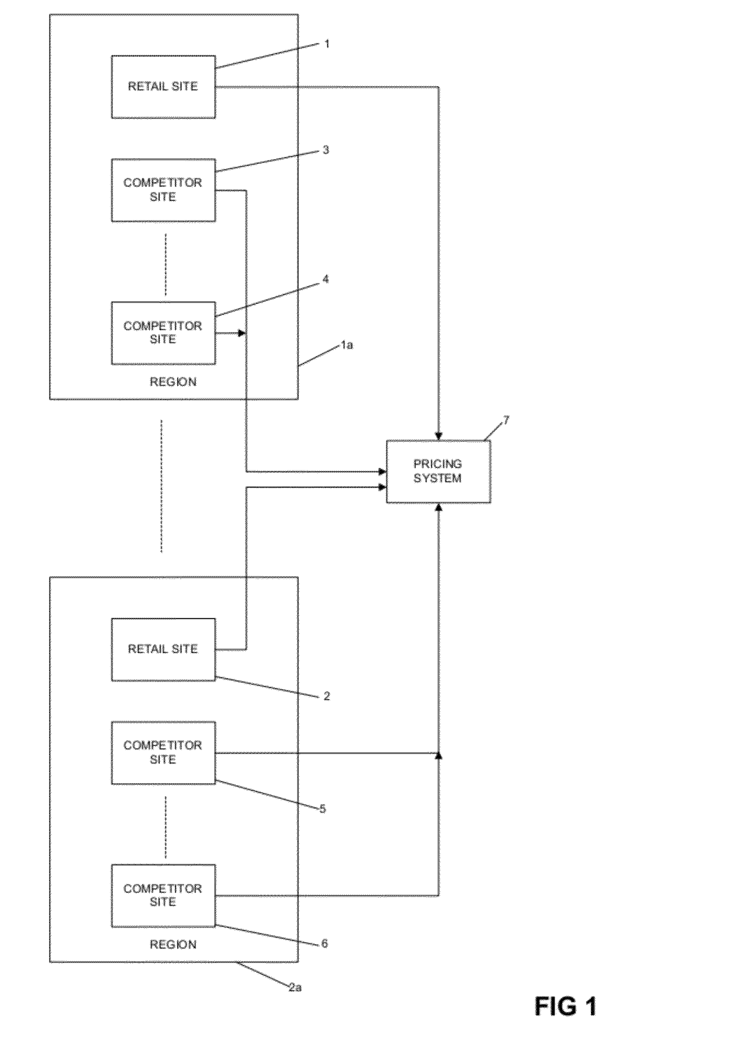

Referring first to FIG. 1 part of a network of associated retail fuel sites, 1, 2 is illustrated. Each of the associated retail fuel sites may be, for example, owned or operated by a single commercial entity, or may be supplied by a particular fuel supplier. Each of the associated retail fuel sites 1, 2 has an associated region 1a, 2a which defines a geographical area in which competitor retail sites 3, 4, 5, 6 are considered to be direct competitors. That is, competitor sites 3, 4 which lie in region 1a are direct competitors of the first associated retail site 1 and competitor sites 5, 6 which lie in region 2a are direct competitors of the second associated retail site 2 such that sales of sites lying in region 1a affect sales of other sites lying in region 1a and sales of sites lying in region 2a affect sales of other sites lying in region 2a. It will be appreciated that a wider area such as a country will generally be divided into a plurality of regions in which retail sites compete with competitor sites. Regions may be selected based upon a geographical region such as an area surrounding a city or may be selected based upon other factors that determine competing sites such as sites located along a particular highway.

Associated retail fuel sites 1, 2 in the network of associated retail fuel sites may further be arranged in networks indicating groups of associated retail fuel sites that share a common pricing strategy such as retail fuel sites located at motorway service stations or retail fuel sites located in urban or rural areas. Additionally, associated retail fuel sites may be operated under various contract types and retail fuel sites operating under particular contract types may also be arranged into networks. Examples of contract types under which retail fuel sites may operate may include “company owned, company operated”, “company owned, franchisee operated”, “dealer owned, dealer operated” and “company owned, dealer operated”. The associated retail fuel sites and competitor retail fuel sites, networks and regions are used to construct a model defining interrelationships between associated retail fuel sites and competitor retail fuel sites. Where changes to the networks and regions subsequently occur, the model defining interrelationships between the sites is updated to reflect the changes.

A pricing system 7 is arranged to receive various data including data associated with each of the associated retail sites 1, 2 and data associated with competitor sites 3, 4, 5, 6. The pricing system 7 is arranged to process the received data and to generate various output data, in particular an optimal pricing strategy for each of the products at each of the associated retail sites 1, 2 based upon the provided information.

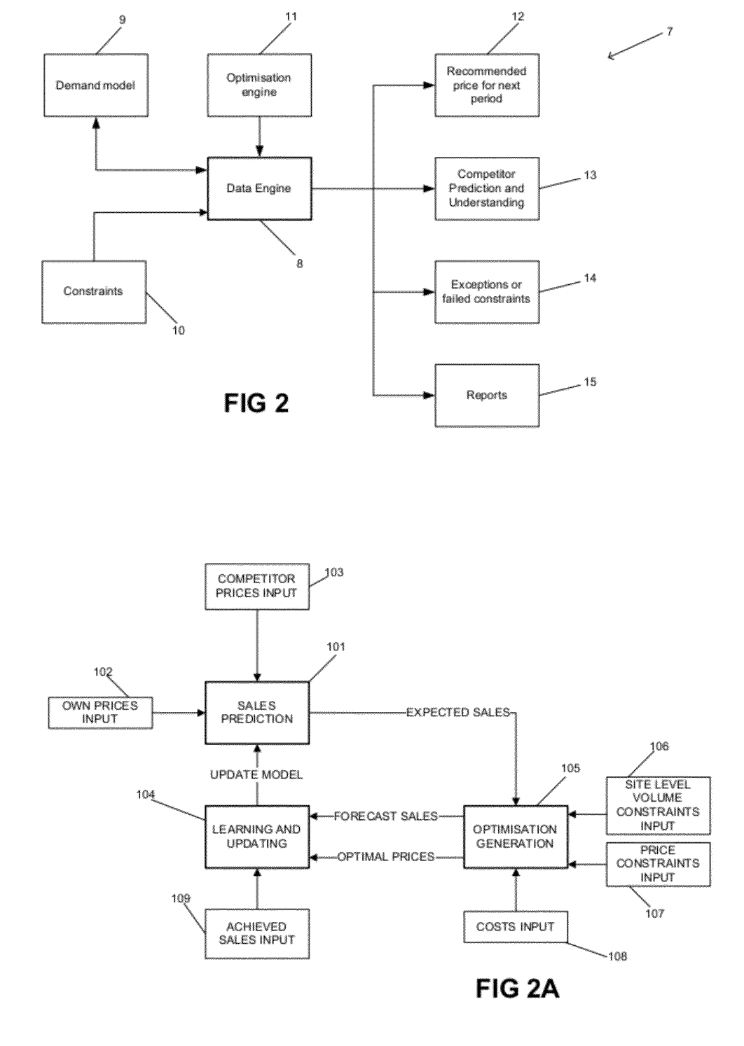

FIG. 2 shows operation of the pricing system 7 of FIG. 1 in more detail. It can be seen that the pricing system 7 takes various data as input, and generates various data as output as described above. Specifically, a data engine 8 takes as input a demand model 9 and constraints 10 and uses an optimisation engine 11. The demand model 9 forecasts sales volume for each product by site and time period. The demand model 9 uses past sales history at each site together with site prices and competitor site prices as well as elasticity values indicating sensitivity of customers to price changes for each product at each associated retail site 1, 2 and time period. The elasticity values provide an estimate of how demand for a particular product is likely to vary in response to price changes, either by an associated retail site 1, 2 or a competitor site 3, 4, 5, 6, and may be determined in an offline process using linear or non-linear regression modelling techniques based upon historic sales and price data. For example, stepwise or ridge regression may be used which are effective techniques for modelling historic price data which is generally highly correlated.

The retail site data and competitor site data may be provided to the pricing system 7 using a data link which automatically provides retail site data to the pricing system 7, for example at the end of each day. Competitor data is collected by the associated retail sites 1, 2 and provided to the pricing system 7 in any convenient way, for example by using the same data link as used to provide retail site data or alternatively using mobile computing devices which are used by operatives to collect the competitor data from the competitor site and which provide the competitor data to the pricing system 7 over wireless telecommunications. Alternatively, data may be provided in any convenient way. An example user interface suitable for inputting site and competitor prices is described below with reference to FIG. 4.

The constraints 10 allows a user to specify rules defining pricing strategies by site and/or product. The rules take the form of price differentials and ranges which it is desirable are satisfied by prices at an associated retail site 1, 2. Price differentials determine a pricing position of a site relative to other competitor sites within a region. Price differentials are used to indicate a range of acceptable prices for a particular product relative to corresponding competitor prices and the data engine 8 seeks to determine product prices which satisfy the specified price differentials. Price differentials may provide different ranges of acceptable prices relative to different competitors and in particular may include a differential relative to a main competitor and additionally or alternatively may include a differential relative to a different site in the network of associated retail fuel sites 1, 2, such that pricing at a first site in the network generally follows pricing at a second site in the network.

Price differentials may either be constraint-type differentials indicating constraints on prices that should be satisfied, often relative to a main competitor for a particular site, or guide-type differentials, which are optional constraints that are to be satisfied where possible, but which may be ignored if they cannot be met. Where a guide-type differential is not satisfied by pricing determined for a particular site, the site may be added to a list of sites to be manually reviewed, for example by an expert analyst or a manager at an associated retail fuel site 1, 2. Alternatively, rules may be relaxed either manually or automatically such that optimal prices can be determined. That is, where it is determined that all of the currently specified rules cannot be satisfied, one or more of the rules may be made less restrictive. The one or more rules may be selected based upon an order which specifies the order in which rules should be relaxed if all of the rules cannot be satisfied.

The optimisation engine 11 is used to determine a set of prices which maximise some objective, whilst attempting to satisfy the rules specified by the constraints 10. In general terms, price optimisation is concerned with balancing profit with volume sales within specified price constraints. The optimisation engine takes as input a policy which indicates the relative importance of profit and volume sales for the optimisation and may be provided as a value between 0 and 100 where 0 indicates that profit is to be maximised and 100 indicates that volume is to be maximised, and values between 0 and 100 indicate relative proportions of profit and volume maximisation. The optimisation engine 11 may additionally be provided with data indicating information about the current market environment which can be taken into account in the generation of prices such as, for example data indicating expected variation in sales in a region or network. Examples of additional information may include data indicating that an event caused a reduction of sales on a particular day, or that a forthcoming event is likely to cause high sales such that strategy should be modified, for example to maximise profit.

The data engine 8 uses the demand model 9, constraints 10 and optimisation engine 11 to generate a recommended price 12 for each product at each associated retail fuel site 1, 2 in the network of associated retail fuel sites using modelling techniques well known in the art. For example, sequential quadratic programming, active set solvers, interior point solvers or other suitable non-linear optimisation techniques may be used to generate the recommended price 12. Additionally, a daily error-correction process such as a Kalman filter or dynamic linear model may be used to update model parameters in light of prediction errors. The data engine 8 may additionally provide output data 13 which can be used to predict competitor price changes, and to understand competitor pricing policies. Data 14 is generated indicating constraints which are specified by the constraints 10 but which are not satisfied by the recommended price 12. Reports 15 may also be generated by the data engine 8. The output data may be provided to the associated retail site 1, 2 in any convenient way, for example using the same method as that used to provide retail site and competitor data to the pricing system 7 from the retail site.

Referring now to FIG. 2A, a schematic functional block diagram of the pricing system is shown. The system has three functional blocks 101, 104, 105 which each take data as input, from external sources and/or from others of the three functional blocks, and each generate output data.

In more detail, a sales prediction block 101 takes as input own prices 102 and competitor prices 103 together with an updated model generated at a learning and updating block 104, and outputs expected sales for the current period. The expected sales output from the sales prediction block 101 are input to an optimisation generation block 105 which also takes as input site level volume constraints 106 (indicating minimum required volume sales for a site), price constraints 107 and costs 108. The optimisation generation block processes its inputs and generates a set of optimal prices and a corresponding forecast of sales, the forecast of sales being based upon the generated set of optimal prices. The forecast of sales and the optimal prices output from the optimisation generation block 105 are input to the learning and updating block 104, together with achieved sales during the period for which the optimal prices were generated and used. The updated model that is passed to the sales prediction block 101 is generated at the learning and updating block 104 based upon the forecast sales for the period and the achieved sales for the period. In this way, the sales prediction for the next period is improved.

The optimal prices for an associated retail fuel site i, generated at the optimisation generation block 105 of FIG. 2A, can be determined by solving an optimisation problem of the form shown in equation (1):

$$maximise {\sum }_{i = 1}^{m} {\sum }_{k = 1}^{p} {G}_{tik} \qquad ( 1 )$$

with respect to own prices: {Pₜᵢₖ}_{i=1 . . . m,k=1 . . . p};
subject to price constraints: {gₗ_{ᵢₖ}≧0}ₗ_{ᵢₖ}_{=1 . . . q}_{ᵢₖ}_{,i=1 . . . m,k=1 . . . p}; and
site level volume constraints:

$${\{ {\sum }_{k}^{ } {V}_{tik} \geq {L}_{ti} \}}_{i = 1 … m}$$

where:
i is an index indicating an ith one of m associated retail fuel sites;
j is an index indicating a jth one of n competitor sites;
k is an index indicating a kth one ofp fuel products;
t is a time period;
Gₜᵢₖ indicates gross profit from sale of grade k at site i in time period t and can be modelled in the form shown below in equation (3);
Pₜᵢₖ indicates the current price of fuel product k at associated retail fuel site i and time t;
lₜₖ is an index indicating an lᵢₖth one of qᵢₖ price constraints indicating constraints on price such as a constraint on price difference between own and competitor products for a particular fuel product k;
gₗ_{ᵢₖ} models the qᵢₖ price constraints as a linear function of own price, cost and competing prices for site i and fuel product k and has the form shown in equation (4) below;
Vₜᵢₖ indicates sales volume in time period t at site i for grade k and can be modelled in the form shown below in equation (2); and
Lₜᵢ indicates a minimum volume target for sales in time period t at site i.

Sales volume can be modelled in the form shown in equation (2):

Vₜᵢₖ=f(Vₛᵢₖ,Pₜᵢₖ,Pₜⱼₖ) (2)

where:
Vₛᵢₖ indicates previous sales at a time s<t;
Pₜⱼₖ indicates the current price of fuel product k at competitor retail fuel site j and time t;
   and
f is a model describing the relationships (referred to as elasticities) between own prices and competitor prices, based upon previous sales Vₛᵢₖ and generally is a log-log or log-linear model. The coefficients of the price terms off are price elasticities. Further details of the form and estimation of the model can be found in, for example the following, which are herein incorporated by reference: Singh, M. G., Bennavail, J.-C, (1993) “Experiments in the use of a knowledge support system for the pricing of gasoline products”, Information & Decision Technologies 18(6): 427-442; Krasteva, E., Singh, M. G., Sotirov, G., Bennavail, J.-C., and Mincoff, N., (1994) “Model Building for pricing decision making in an uncertain environment, Proc. IEEE International Conference on Systems, Man and Cybernetics”, San Antonio; and Bitran, G., Caldentey, R. and Mondeschein, S. (1998) “Coordinating clearance markdown sales of seasonal products in retail chains”, Operations Research 46(5): 609-624.

Accordingly gross profit Gₜᵢₖ can be modelled as shown in equation (3):

$${G}_{tik} = ( \frac{{P}_{tik}}{1 + v} - {C}_{tik} ) {V}_{tik} = ( \frac{{P}_{tik}}{1 + v} - {C}_{tik} ) f ( {V}_{sik} , {P}_{tik} , {P}_{tjk} ) \qquad ( 3 )$$

where:
Pₜᵢₖ indicates current price of fuel product k at site i and time t as above;
Cₜᵢₖ indicates direct sales costs for fuel product k in time period t at site i; and
v is the applicable sales tax rate.

The price constraints gₗ_{ₖ} can be modelled in the form shown in equation (4):

gₗ_{ᵢₖ}(Pₜᵢₖ,Cₜᵢₖ,Pₜⱼₖ)≧0 (4)

where Pₜᵢₖ, Cₜᵢₖ and Pₜⱼₖ are as described above.

The optimisation problem of equation (1) can be solved using non-linear optimisation techniques well known in the art such as those described in Gill, P. E., Murray, W., and Wright, M. H., “Practical Optimisation” (1981), Academic Press, which is herein incorporated by reference. The optimisation provides a set of prices Pₜᵢₖ, indicating an optimal price at each site for each fuel product given various constraints that are applicable at the current time t.

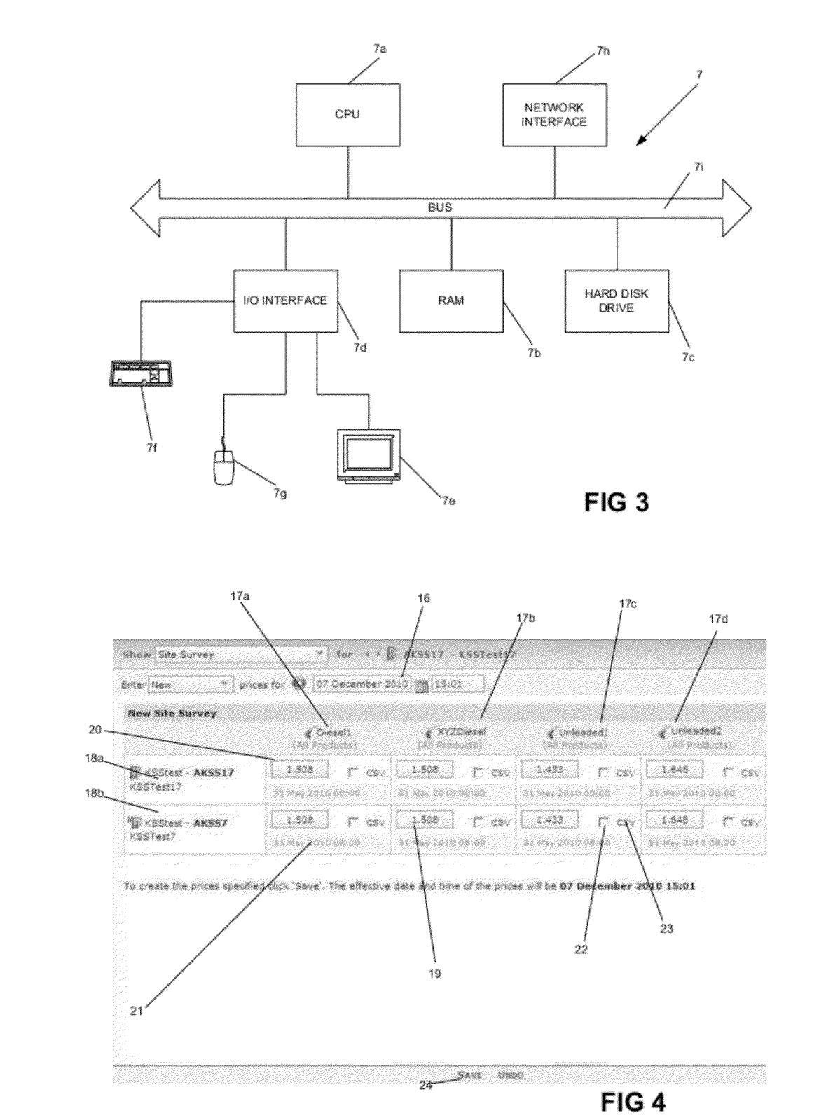

FIG. 3 shows a computer associated with the pricing system 7 of the system of FIG. 1 in further detail. It can be seen that the computer associated with the pricing system comprises a CPU 7a which is configured to read and execute instructions stored in a volatile memory 7b which takes the form of a random access memory. The volatile memory 7b stores instructions for execution by the CPU 7a and data used by those instructions. For example, in use, software used to determine optimal prices for retail fuel sites may be stored in volatile memory 7b.

The computer associated with the pricing system 7 further comprises non-volatile storage in the form of a hard disc drive 7c. Data such as retail fuel site data and competitor site data may be stored in the hard disc drive 7c. The computer associated with the pricing system 7 further comprises an I/O interface 7d to which are connected peripheral devices used in connection with the computer associated with the pricing system 7. The computer associated with the pricing system 7 has a display 7e configured so as to display output from the data engine. Input devices are also connected to the I/O interface 7d. Such input devices include a keyboard 7f, and a mouse 7g which allow user interaction with the data engine. A network interface 7h allows the computer associated with the pricing system 7 to be connected to an appropriate computer network so as to receive and transmit data from and to other computing devices such as computing devices provided at the retail fuel sites. The CPU 7a, volatile memory 7b, hard disc drive 7c, I/O interface 7d, and network interface 7h, are connected together by a bus 7i.

It has been indicated above that associated retail fuel site and competitor site prices are provided to the pricing system 7. Referring to FIG. 4, a user interface suitable for inputting product prices for a site and its competitors is shown. The time and date for which the data applies is provided using date and time fields 16. Headers 17a, 17b, 17c and 17d indicate different products available at the site for which data is to be entered. A row 18a provides data display and entry for an associated retail fuel site “AKSS17” and a row 18b provides data entry and display for a competitor retail fuel site. Other rows may be provided to provide data entry and display for further competitor retail fuel sites, as determined from the model defining interrelationships between the sites.

Price fields 19, 20 provide editable fields in which price data associated with each product and site is entered and/or displayed. For example, price field 19 provides a field in which price data for product “Diesel1” at site “AKSS7” is entered and displayed and price field 20 provides a field in which price data for product “XYZDiesel” at site “AKSS17” is entered and displayed. Price fields 19, 20 may be provided with associated logic which defines maximum and minimum values. Each price field 19, 20 has an associated time and date stamp 21 which indicates the time and date of the last change to the price displayed in the time and date field. A check box 22 associated with each price field 19, 20 allows a user of the user interface to select whether the input data should be updated in the pricing system 7 and a price entry marker 23 associated with each price field 19, 20 indicates the source of the displayed value. The source of the displayed value may be one of user entered, entered following site survey, file input, entered via error browser or set by pricing system. Upon selection of a “save” button 24 data that has been entered into the user interface is submitted to the data engine, and in particular values in the demand model are updated.

In some embodiments the output data may be used to cause automatic update of optimal fuel prices at the associated retail fuel sites 1, 2, for example by providing data to a computer located at the associated retail fuel sites 1, 2 which is in communication with pumps, tills and signage at the associated retail fuel sites. Where automatic update of optimal fuel prices is used, it is generally necessary to carry out the update at a time when the associated retail fuel sites 1, 2 are not operational. However in general output data is provided to the associated retail fuel sites 1, 2 and fuel prices are changed by way of at least some manual intervention. For example, a manager of each associated retail fuel site 1, 2 may receive at least some of the output data generated by the pricing system 7 and may then decide what fuel price changes to implement.

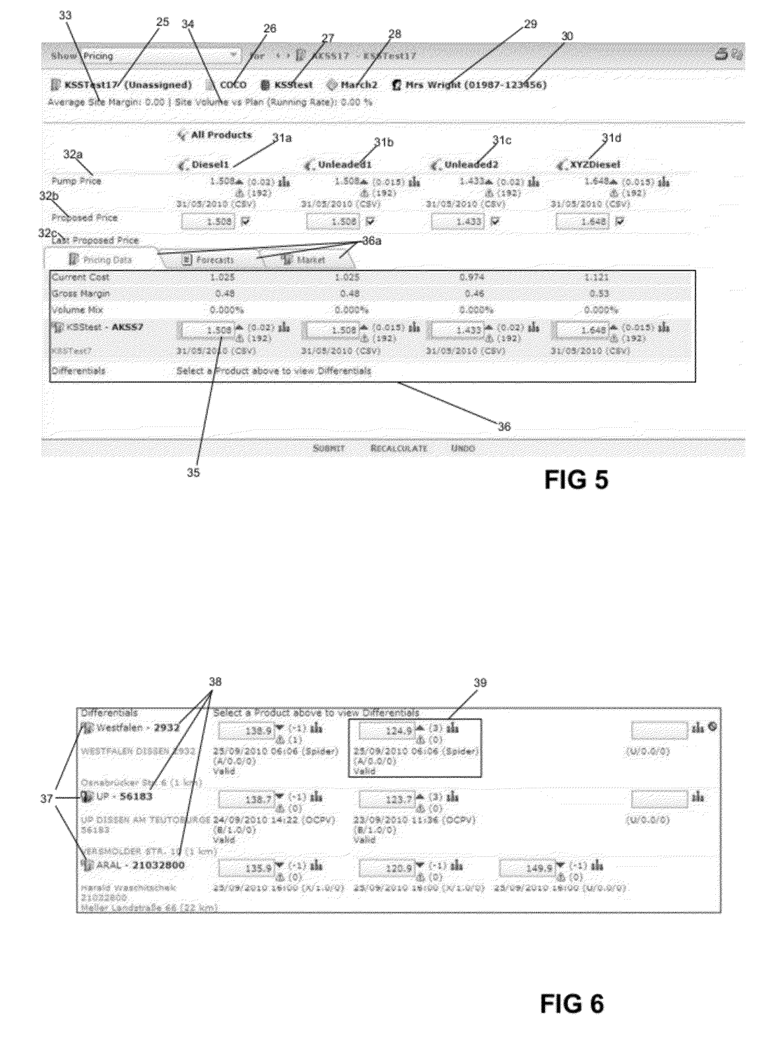

As indicated above, various output data relevant to each site is generated and provided to associated retail fuel sites 1, 2. The output data provided to each site may be displayed on a pricing page which provides data relevant to the particular retail fuel site such as the pricing page of FIG. 5. For example, the pricing page may display site details including the name of the site 25, contract type 26, brand 27, area 28, area manager name 29 and contact number 30 associated with the retail fuel site. Headers 31a, 31b, 31c and 31d indicate different products available at the site and data relevant to each product is displayed in columns beneath each header. The data relevant to each product includes pump price data displayed in a row indicated by header 32a which is described in further detail below with reference to FIG. 6, a proposed price field displayed in a row indicated by header 32b which includes an editable price field into which price changes can be entered and a check box which indicates whether an entered price should be updated in the pricing system 7, and a last proposed price displayed in a row indicated by header 32c. Average site margin 33 indicating the average margin across all fuel products at the site is displayed, together with an indication 34 of the percentage running rate indicating the percentage of planned target sales volume in the current planning period that have actually been achieved, where the planned target sales volume is calculated by multiplying the total target sales volume in the current planning period by the proportion of time that has passed in the current planning period.

Additionally, tabs 36a allow a user to selectively display one of further pricing data, forecasts and market data in screen area 36. In FIG. 5 the pricing data tab is selected such that further pricing data is shown. Selection of the forecasts tab of the tabs 36a causes screen area 36 to display calculated forecast values for each of volume, profit and profit per unit volume for each product based upon the current proposed price for each product together with a change relative to a previous forecast for each of the forecasts. Selection of the market tab of the tabs 36a causes pricing details of competitor sites to be displayed for each product sold at both the current site (as indicated by the name of the site 25) and competitor sites.

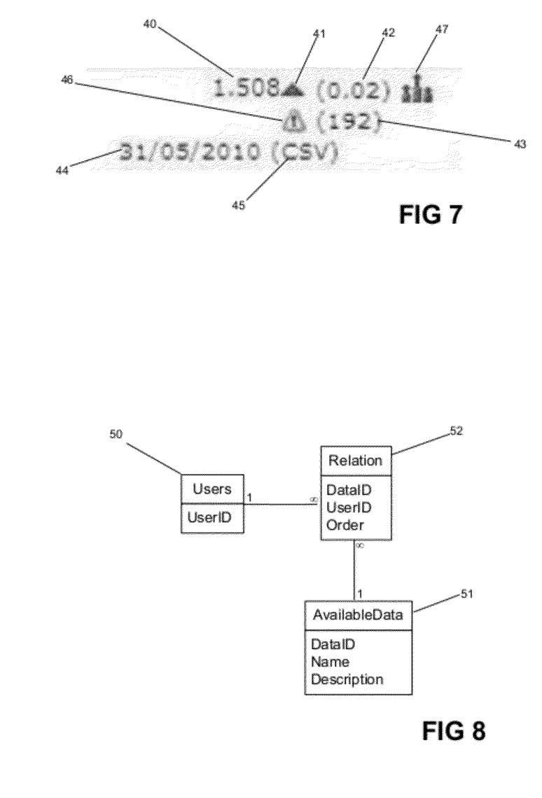

An example pump price data displayed for product “Diesel1” of FIG. 5 is shown in FIG. 7. It will be appreciated that competitor pump price data displayed upon selection of the market tab has the same form. The pump price data includes a current pump price 40 and a price movement indicator 41 which indicates whether the current pump price 40 is higher, lower or equal to the previous pump price. The difference 42 between the current pump price 40 and the previous pump price is also indicated together with the number of days 43 since the last price change. Date stamp 44 indicates the date that the current pump price was last modified and a source stamp 45 indicates how the current pump price was modified such as user entered, entered following site survey, file input, entered via an error browser or set by pricing system. Additionally an icon 46 may be provided to indicate one or all of: the displayed price has not been updated within a predetermined number of days; the displayed price was amended by a user other than the current user; the displayed competitor price is not active, that is, the displayed competitor price is excluded from processing, for example due it not having been validated; the displayed competitor price has been verified by a third party source; and the displayed competitor price cannot be verified by a third part source. Where it is indicated that the displayed competitor price cannot be verified by a third party source, a check box may be displayed which allows a user to verify the price manually. Selection of an icon 47 causes a chart of historic price data and/or sales volume data to be displayed for the relevant item.

The pricing page is configurable such that information may be displayed to a user according to predefined preferences for that user. The predefined preferences may be selected by the user or may be selected for each user on the basis of a property of the user, such as for example the contract type for a retail fuel site associated with the user. In this way, the information that is most relevant and/or useful to the user is provided. The pricing page shows a layout that corresponds to the pricing page and allows types of data to be specified in areas of the layout for a particular user such that the specified data is displayed in corresponding areas of the pricing page that is displayed to the user.

Further details of the pricing page can be found in applicant's co-pending U.S. patent application filed 28 Jan. 2011 with application Ser. No. 13/016,378, which is herein incorporated by reference.

Various data can be configured to be displayed within screen areas of the pricing page. For example, site details such as a rolling run rate indicating a total achieved volume sales as a percentage of total volume over weighted planning periods, may be displayed in addition to or in place of, for example, percentage running rate 34 shown in FIG. 5. Examples of data that may be displayed in area 36 shown in FIG. 5 in addition to or in place of one or more of the current cost, gross margin, volume mix and price differentials shown in FIG. 5 include: an average competitor price indicating the average price for each product across all competitor sites; a card price indicating the pump price minus a specified discount value; competitor data showing details of competitor sites; a delivery cost indicating a total cost associated with delivering a unit of each fuel product to a customer; a future price indicating details of prices that are to be applied at a predetermined time in the future; like for like volumes indicating volume sales for each product over a predetermined time period as a percentage of volume sales for the product over the same time period in a previous year; a policy for each product indicating a volume sales target for the product; and superseded prices indicating details of prices that have been replaced. The future price for each product may include details of a price to be applied at a time in the future, the time at which the price is applicable and data associated with the origin of the price. Similar details may be provided for superseded prices. It will be appreciated that any other suitable screen area and data field may be configured to either be displayed or to not be displayed, in order to configure the pricing page to different users' requirements.

Data associated with the display of data on a pricing page for users may be stored in any convenient form. For example, FIG. 8 is an entity diagram of a database suitable for storing and managing data to be displayed as part of a pricing page for different users. As shown in FIG. 8, the database has three tables: a Users table 50; an AvailableData table 51 and a Relation table 52. Each entry of the Users table 50 is associated with a user of the system, each entry of the AvailableData table 51 is associated with a data item that may be displayed as part of a pricing page and each entry of the Relation table 52 indicates a relationship between a user and a data item, together with an order associated with display of the data item.

The Users table 50 has a UserID field which is its primary key, and may additionally have fields for storing data associated with each user such as a name field. The AvailableData table 51 has a dataID field which is its primary key, a Name field for storing the name of a data item and a Description field for storing a description of the data item. The Relation table 52 has a DataID field which identifies a record of the AvailableData table 51, a UserID field which identifies a record of the Users table 50 and an Order field which defines an order for display of the data item identified by the DataID field relative to other data items to be displayed.

When a pricing page is to be displayed for a particular user a lookup is carried out to identify all records of the Relation table 52 having a UserID corresponding to the UserID of the particular user. The DataID of each identified record identifies a record of the AvailableData table 61 which corresponds to a data item to be displayed as part of the pricing page which can then be displayed to the user.

In the optimisation of equations (1) to (4), where two associated retail sites i,j are indicated as sites whose sales affect each other then pricing changes at retail site i will impact sales at retail site j and vice versa. Similarly, if a price constraint on a product at an associated retail site i depends on the value of a price for the product on an associated retail site j, prices at sites i and j will also be interdependent. These cases are, however, exceptional, and in general profit is maximised for each associated retail site independently of other ones of the m associated retail sites by providing a set of optimal prices for each site which satisfy the set of constraints for that site, and in particular that satisfies the site level volume constraint Lₜᵢ for that site.

In existing systems the site level volume constraints Lₜᵢ for each associated retail site i are set for each site independently of other associated retail sites, generally using actual volume sales from the previous month at that site and possibly varying positively or negatively by a percentage of the previous month actual volume sales. However, site level volume constraints Lₜᵢ can be set in such a way that total network volume sales are maintained and such that profit across the whole network of associated retail fuel sites is therefore optimised. Setting of site level volume constraints in such a way that total network volume sales are maintained and such that profit across the whole network of associated retail fuel sites is described in applicant's co-pending U.S. patent application filed 16 Feb. 2011 with application Ser. No. 13/028,543, which is herein incorporated by reference and in general terms comprises a first stage in which average prices and costs across a recent time period are used to determine an optimal set of site level volume constraints, and those determined site level volume constraints are subsequently used in the optimisation described above.

It should be noted that in the above description the terms “optimal” and “optimised” are intended to mean generated using processing intended to select values based upon data. The values will generally be improved relative to a previous value and sometimes be a best possible value, but this is not necessarily the case.

The optimisation described above uses a model f describing the relationships between own prices and competitor prices, based upon previous sales Vₛᵢₖ. The coefficients of the price terms off are price elasticities. The model therefore takes as input elasticities, between prices at a retail fuel site and sales at the retail fuel site (referred to as a direct elasticity), and competitor prices and sales at the retail fuel site (referred to as cross elasticities), and those elasticities provide valuable input into the pricing decision process and influence the potential profit of the retail fuel site.

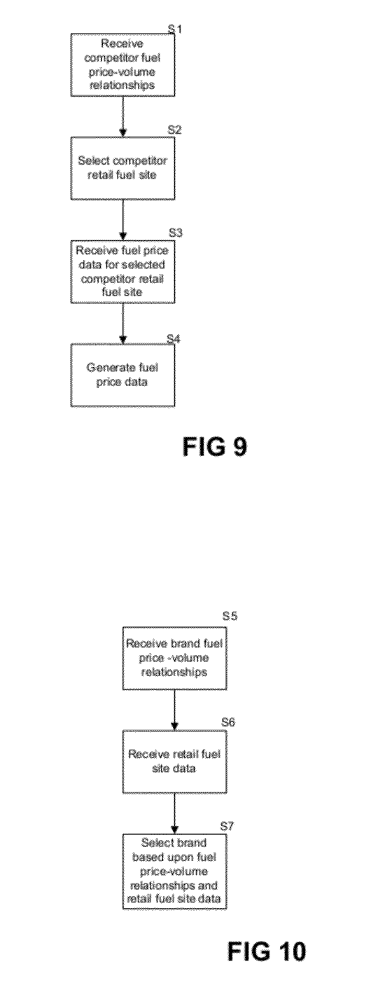

The optimisation for a retail fuel site further takes as input price constraints which are set based upon pricing at one or more competitor sites. Methods for improved determination of price constraints will therefore now be described with reference to FIG. 9. At step S1 data indicating a relationship between the retail fuel site and each of a plurality of competitor retail fuel sites is received. The relationship is a cross elasticity and provides an estimate of the effect of a price change at a competitor fuel site on sales at the retail fuel site. Methods for determining relationships between retail fuel sites and competitor retail fuel sites are described below.

At step S2 the received data is processed to select a competitor retail fuel site of the plurality of competitor retail fuel sites based upon the data received at step S1. In particular, the relationship data received at step S1 provides an indication of the effect of fuel price at a competitor retail fuel site on sales at the retail fuel site, and as such provides an indication of the competitor retail fuel site that is most significant to sales at the retail fuel site. As such, the competitor site for which price has the greatest effect on sales at the retail fuel site is selected.

At step S3 fuel price data for the selected competitor retail fuel site is received. The fuel price data takes the form of current fuel prices at the competitor retail fuel site. At step S4 fuel price data is generated for the retail fuel site based upon the fuel price data received at step S3. The fuel price data generated at step S4 may be generated, for example, using the optimisation of equation (1) in which price constraints gₗ_{ᵢₖ} are set based upon the fuel price data for the selected competitor retail fuel site received at step S3. In this way, fuel prices for the retail fuel site can be maintained within predefined limits of the competitor retail fuel site which has the greatest effect on fuel sales at the retail fuel site.

Whilst the above description indicates that a single competitor retail fuel site is selected, it will be appreciated that in general at least one competitor retail fuel site is selected at step S2 and typically a plurality of competitor retail fuel sites are selected that have the greatest effect on fuel sales at the retail fuel site. For example, price constraints may be set such that prices remain within a predetermined range of each of the selected competitor retail fuel sites.

Some properties of a retail fuel site that influence direct elasticity of the retail fuel site, such as retail fuel site location, are predetermined and either cannot be changed or are difficult or undesirable to change. However other properties of a retail fuel site that influence elasticities, can typically be selected relatively freely. For example different brands of fuel that are available to be sold at a retail fuel site may be viewed differently by potential customers, for example based upon a reputation for value for money, cleanliness, on-site security or quality of service of the brand. The different way in which the brand is viewed can affect the likelihood of potential customers to be influenced by fuel price, and as such can affect the direct elasticity of the retail fuel site.

Methods for improving selection of properties of a retail fuel site will now be described with reference to FIG. 10. At step S5 fuel price-volume relationships for each of a plurality of brands are received. Each of the plurality of brands is a brand that the retail fuel site has the option of selling and the price-volume relationships indicate how sensitive volume fuel sales are to price variation for each of the brands. The fuel price-volume relationship for each brand may be generated based upon historical data as described in detail below.

At step S6 retail fuel site data indicative of a fuel price-volume relationship for the retail fuel site is received. The retail fuel site data is generally a fuel price-volume relationship generated based upon historical data for the retail fuel site where such historical data exists. However, where no historical data exists, for example, where the retail fuel site is a new retail fuel site, the fuel data indicative of a fuel price-volume relationship may be based upon properties of the retail fuel site such as location of the retail fuel site.

At step S7 the data received at steps S5 and S6 is processed to select a brand of the plurality of brands that is optimal for the pricing strategy of the retail fuel site. The brand is selected for a retail fuel site such that the effect of the brand on the fuel price-volume relationship compliments the effect of other factors that cannot be varied on the fuel price-volume relationship. For example, where fuel sales at a site are relatively sensitive to price changes then a brand that customers associate with properties such as value for money and which therefore will typically have a relatively strong fuel price-volume relationship associated with it is selected. Conversely, where fuel sales at a site are relatively insensitive to price changes then a brand that customers associate with properties such as added value and which therefore will typically have a relatively weak fuel price-volume relationship such that increases in fuel price do not strongly affect sales is selected such that customers are happier to pay higher prices to obtain such added value.

For example, in a fuel pricing strategy described in applicant's co-pending U.S. patent application filed 16 Feb. 2011 with application Ser. No. 13/028,543, which is herein incorporated by reference, profit is optimised across a network of associated retail fuel sites using a network optimisation pricing strategy. In very general terms, the pricing strategy sets fuel prices relatively low at retail fuel sites in which fuel sales volume is relatively sensitive to fuel price, such that fuel sales volume is relatively high at those sites. Fuel prices at sites at which fuel sales volume is relatively insensitive to fuel price are set relatively high such that profit on fuel sales is relatively high at those sites. In this way, total volume sales remain relatively even but fuel sales profit is increased. By selecting brand to compliment the fuel price-volume relationship, the effect of such a strategy on profit can be enhanced.

A similar enhancement can be achieved in a fuel pricing strategy described in applicant's co-pending U.S. patent application filed 4 May 2011 with application Ser. No. 13/100,566, which is herein incorporated by reference, in which profit is maximised for a store based upon store sales and fuel sales for the retail fuel site.

The methods described above with reference to FIGS. 9 and 10 each use fuel price—volume relationships, with the method of FIG. 9 using relationships between a site and competitor sites (or cross elasticities) and the method of FIG. 10 using relationships between own price and volume sales (or direct elasticities). The relationships may be determined in any convenient way. For example, a hierarchical demand model in which competitor sites have separate elasticity estimates and in which the estimates are assumed to come from a common distribution may be fitted to historical data for each of the competitors. A preferred method for determining elasticities based upon fitting a Bayesian hierarchical model to historical data will now be described.

The Bayesian hierarchical model models the relationship between a plurality of entities i=1 . . . m, where each entity is either a retail fuel site or a brand, by way of a plurality of regression equations of the form (5):

yᵢ=Xᵢβᵢ+εᵢ (5)

where:
yᵢ is logged sales volumes per time period at entity i;
Xᵢ is a k-dimensional data vector of logged prices at entity i and competing entities per time period; and
βᵢ is a k-dimensional parameter vector of the form βᵢ=(αᵢ, β₀ᵢ, β₁ᵢ, . . . , βₖᵢ), where αᵢ is . . . , β₀ᵢ is the direct elasticity for entity i, and βⱼᵢj=1 . . . k is the cross elasticity for entities i and j.

Each regression equation has a separate prior on the error of the form (6):

εᵢ˜iidN(0,σᵢ²) (6)

The independent regression equations are linked by assuming that the parameter vectors βᵢ have a common prior distribution in the form of a multivariate regression model of the form (7):

B=ZΔ+V (7)

where:
B is an m×k matrix of the form (8) below;
Z is an m×d matrix of the form (9) below, where d is the number of attributes of each entity;
Δ is a d×k matrix of the form (10) below; and
vₗ^{′}˜N(0,V_{β}) where V_{β} is the k×k covariance matrix of β.

Each column of Δ has coefficients that describe how the mean of the corresponding components of β varies as a function of the data in the z variables.

$$\begin{matrix}B = [ \begin{matrix}{β}_{i}^{′} \\ ⋮ \\ {β}_{m}^{′}\end{matrix} ] & ( 8 ) \\ Z = [ \begin{matrix}{z}_{1}^{′} \\ ⋮ \\ {z}_{m}^{′}\end{matrix} ] & ( 9 ) \\ Δ = [ {δ}_{1} … {δ}_{k} ] & ( 10 )\end{matrix}$$

The model may be estimated using Monte-Carlo Markov chain techniques in which priors are specified in the form of the conditional distributions shown in equation (11) below.

yᵢ|Xᵢ,βᵢ,Γᵢ²

βᵢ|zᵢ,Δ,V_{β}

σᵢ²|vᵢ,s₀ᵢ²

V_{β}|v,V

Δ|V_{β}, Δ̅,A (11)

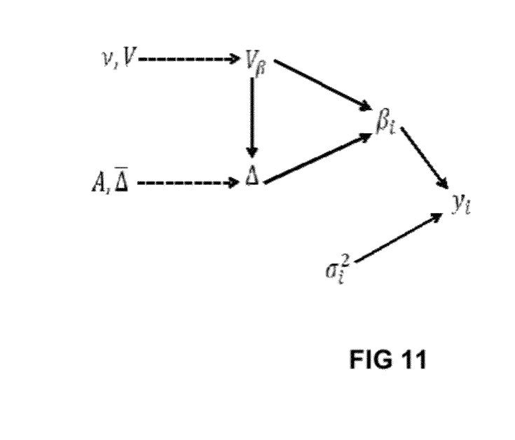

The conditional distributions shown in equation (11) represent an assumption that the parameters Δ and V_{β} are conditionally independent of sales data yᵢ and price data Xᵢ given the regression coefficients βᵢ, as represented in FIG. 11. The prior distribution of Δ is represented by a normal distribution as shown in equation (12):

Δ˜N( Δ̅,V_{β}\textcircled{×}A⁻¹) (12)

and the prior distribution of V_{β} is specified by an inverse Wishart distribution as shown in equation (13).

V_{β}˜IW(v,V) (13)

The prior of the (m×k)-dimensional joint distribution of β is thus fully specified by choice of the hyper-parameters Δ̅, A, v, V. An inverse chi-squared prior on each error variance σᵢ² in the form (14) is also specified.

$${σ}_{i}^{2} \sim \frac{{v}_{i} {s}_{01}^{2}}{{χ}_{{v}_{i}}^{2}} \qquad ( 14 )$$

Diffuse prior settings for Δ̅, A, v, V and sᵢ₀² have been found to be suitable given the large data volumes available and are shown in (15).

Δ̅=0

A=0.01

v=k+3

V=v*0.1Iₖ

s₀ᵢ²=var(yᵢ) (15)

Given the conditional distributions of equation (11) and the assumption that the parameters Δ and V_{β} are conditionally independent of sales data yᵢ and price data Xᵢ, the model can be estimated using a Gibbs sampler which uses a plurality of iterations to generate a Monte Carlo simulation of the posterior distribution of each parameter of the parameter vector β. Each iteration first draws βᵢ and σᵢ² for each entity from a set of univariate normal posteriors conditioned on the draws of Δ and V_{β} from the previous iteration and subsequently draws Δ and V_{β} from a multivariate normal regression posterior conditioned on βᵢ.

The Gibbs sampler may be implemented in any convenient way, for example using the bayesm package within the R statistical environment which can be obtained from www.r-project.org, or using the WinBUGS package which can be obtained from www.mrc-bsu.cam.ac.uk/bugs/winbugs/contents.shtml.

The Bayesian hierarchical model described above with reference to equations (5) to (15) is applied to historical data providing information for the modelled entities. The historical data may be provided from any convenient source, for example using: government data estimates of total gasoline sales by US state and month; data collected from fuel cards or loyalty cards on share of the retail fuel market by brand of fuel, state and week; by purchasing data on fuel prices, sales volume estimates and/or market share estimates from data survey companies; or by direct observation at retail fuel sites. Alternatively, where a company owns a plurality of sites, historical data from that plurality of sites may be used.

The model can be applied to historical sales and price data for a retail fuel site and a plurality of competitor retail fuel sites to determine the competitor fuel price-volume relationships for the retail fuel site received at step S1 of FIG. 9 in the manner that will now be described. By assuming that each site has the same total number k of competitor sites, the retail fuel site and each competitor retail fuel site can be modelled as an entity in the form (16), corresponding to the entities of equation (5):

$$log ( {V}_{i} ) = {α}_{i} + {β}_{0 i} log ( {p}_{0 i} ) + {\sum }_{j = 1}^{k} {β}_{ji} log ( {p}_{ji} ) + {ɛ}_{i} \qquad ( 16 )$$

where:
αᵢ is the regression intercept and represents log of average sales volume for site i;
β₀ᵢ is the direct elasticity for site i;
Vᵢ is daily total sales volume at site i for a given grade of fuel;
p₀ᵢ is average daily price at site i; and
pⱼᵢ is average daily price at j=1, . . . , k competitor sites.

Setting Z to be a column of 1s in equation (7) means that upon estimating the model Δ evaluates to a row vector containing estimates of the means of (αᵢ, β₀ᵢ, β₁ᵢ, . . . , βₖᵢ), corresponding to the direct elasticity for the site i and the cross elasticities between site i and each of the sites j. The values βⱼᵢ therefore provide the input relationships at step S1 of FIG. 9.

Where each entity is associated with a different brand the output data provides an indication of elasticities for each brand. Alternatively, elasticities for brands can be determined based upon market share and average price data for all brands in a given region, such as a US state, by modelling each brand as an entity in the above as will now be described.

Market share for a brand jε{1, . . . , m} in week t in the given region, Mⱼₜ can be modelled by equation (17):

$${M}_{jt} = {( \frac{{N}_{jt}}{{W}_{t}} )}^{{α}_{0}} {{P}^{⋒}}_{jt}^{{β}_{0}} {\prod }_{{i = 1}_{i \neq j}}^{m} {{P}^{⋒}}_{it}^{{γ}_{i}} \qquad ( 17 )$$

where:
Nⱼₜ is the number of sites for brand j;
Wₜ is the total number of sites over all brands; and

$${{P}^{⋒}}_{jt}^{{β}_{0}} = \frac{{P}_{jt}}{{\overline{P}}_{t}}$$

where Pⱼₜ is the average retail price for brand j in week t and P̅ₜ is the average retail price over all brands in week t given by

$${\overline{P}}_{t} = {\sum }_{j = 1}^{m} \frac{{P}_{jt}}{m} .$$

Since market shares Mⱼₜ sum to 1, equation (18) follows, for each j=1, . . . , m:

$$0 = \frac{\partial 1}{\partial {{P}^{⋒}}_{jt}} = {\sum }_{l = 1}^{m} \frac{\partial {M}_{it}}{\partial {{P}^{⋒}}_{jt}} = \frac{\partial {M}_{jt}}{\partial {{P}^{⋒}}_{jt}} + {\sum }_{{i = 1}_{i \neq j}}^{m} \frac{\partial {M}_{it}}{\partial {{P}^{⋒}}_{jt}} = {β}_{0} \frac{{M}_{jt}}{{{P}^{⋒}}_{jt}} + {\sum }_{{i = 1}_{i \neq j}}^{m} {γ}_{j} \frac{{M}_{it}}{{{P}^{⋒}}_{jt}} \qquad ( 18 )$$

which can be rewritten as equation (19).

$$0 = {β}_{0} {M}_{jt} + {\sum }_{{i = 1}_{i \neq j}}^{m} {γ}_{j} {M}_{it} \qquad ( 19 )$$

Since equation (19) is true for all t, Mⱼₜ can be averaged with respect to t to give γⱼ as defined in equation (20):

$${γ}_{j} = - {β}_{0} \frac{{\overline{M}}_{j}}{{\sum }_{i \neq j}^{ } {\overline{M}}_{i}} \qquad ( 20 )$$

where M̅₁ indicates an average market share over time t for brand j.

Time averaged market shares must also sum to 1, and so equation (20) can be rewritten as equation (21):

$${γ}_{j} = - {β}_{0} \frac{{\overline{M}}_{j}}{1 - {\overline{M}}_{j}} \qquad ( 21 )$$

which indicates that the m global cross elasticity parameters γⱼ are dependent on the direct elasticity for the corresponding brand.

Each entity can therefore be modelled as shown in equation (22), corresponding to the entities (5):

$$log ( {M}_{jt} ) = {α}_{0} log ( \frac{{N}_{jt}}{{W}_{t}} ) + {β}_{0} ( log ( {{P}^{⋒}}_{jt} ) - {\sum }_{i \neq j}^{ } \frac{{\overline{M}}_{i}}{1 - {\overline{M}}_{i}} log ( {{P}^{⋒}}_{it} ) ) \qquad ( 22 )$$

with two independent coefficients α₀, β₀.

It can be assumed that each direct elasticity comprises a brand component βⱼ such that the total direct elasticity for each brand is given by (β₀+βⱼ), where β₀ is a global direct elasticity. By assuming that the βⱼ are random variables with mean zero, (β₀+βⱼ) can be viewed as a being drawn from a global prior distribution with mean β₀.

The global cross elasticity of brand i, γᵢ, can be viewed as comprising a brand specific adjustment γᵢ^{j} in the same way, and define the cross elasticity adjustments as shown in equation (23):

$${γ}_{i} + {γ}_{i}^{j} = - ( {β}_{0} + {β}_{j} ) \frac{{\overline{M}}_{i}}{1 - {\overline{M}}_{i}} \qquad ( 23 )$$

which provides m−1 relationships involving γᵢ. A further relationship is provided by equation (24):

$${γ}_{j} + {γ}_{j}^{j} = - ( {β}_{0} + {β}_{j} ) \frac{{\overline{M}}_{j}}{1 - {\overline{M}}_{j}} \qquad ( 24 )$$

where γⱼ^{j} is an adjustment term defined by equation (25):

$${γ}_{j} + {γ}_{j}^{j} = \frac{1}{1 - {\overline{M}}_{j}} {\sum }_{{i = 1}_{i \neq j}}^{m} ( {γ}_{j} + {γ}_{j}^{i} ) {\overline{M}}_{i} \qquad ( 25 )$$

which represents the notional adjustment to the global cross elasticity for brand j when appearing in the equation for brand j market share. Since there are m relationships of the same form for the term γᵢ+γᵢ^{j}, it follows that the mean of γᵢ+γᵢ^{j} over all i is equal to γᵢ and accordingly for any given i the random variable γᵢ^{j} has mean zero.

For modelling reasons a brand specific component is introduced into the scale parameter α=α₀+αⱼ so that αⱼ is also modelled as drawn from a global prior distribution with mean α₀.

Writing α₀+αⱼ as αⱼ and β₀+βⱼ as βⱼ, with α₀ and β₀ denoting the means of the distributions of αⱼ and βⱼ the hierarchical model of brand market share has j=1, . . . , m equations at the lower level of the form (26):

$$log ( {M}_{jt} ) = {α}_{j} log ( \frac{{N}_{jt}}{{W}_{t}} ) + {β}_{j} ( log ( {{P}^{⋒}}_{jt} ) - {\sum }_{i \neq j}^{ } \frac{{\overline{M}}_{i}}{1 - {\overline{M}}_{i}} log ( {{P}^{⋒}}_{it} ) ) + {ɛ}_{jt} \qquad ( 26 )$$

where εⱼₜ˜iidN(0,σⱼ²).

An upper level multivariate regression for the common prior of the αⱼ and βⱼ is given by (27), corresponding to equations (7) to (10):

$$B = Z Δ + V , B = [ \begin{matrix}{α}_{1} {β}_{1} \\ ⋮ \\ {α}_{m} {β}_{m}\end{matrix} ] , Z = [ \begin{matrix}1 \\ ⋮ \\ 1\end{matrix} ] , Δ = [ {α}_{0} {β}_{0} ] \qquad ( 27 )$$

The model is estimated using a Gibbs sampler, as described above, to provide estimates of the elasticities, which can be used as input at step S5 of FIG. 10.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A computer-implemented method of selecting a fuel type for a retail fuel site, the method being implemented in a computer comprising a memory in communication with a processor, the method comprising:
receiving, as input to the processor, data indicating a relationship between fuel price and fuel sales for a plurality of fuel types;
receiving, as input to the processor, data indicating a property of the retail fuel site; and
processing, by the processor, the data indicating a relationship between fuel price and fuel sales for each of the plurality of fuel types and the data indicating a property of the retail fuel site to select the fuel type for the retail fuel site.

2. A computer-implemented method according to claim 1, wherein said property is based upon a location of said retail fuel site.

3. A computer-implemented method according to claim 1, wherein said property is a property associated with a relationship between fuel price and fuel sales for said retail fuel site.

4. A computer-implemented method according to claim 3, wherein said processing comprises:
determining, by the processor, a relationship between fuel price and fuel sales for said retail fuel site based upon said property; and
wherein said fuel type is selected based upon said determined relationship for said retail fuel site and said relationships for each of said plurality of fuel types.

5. A computer-implemented method according to claim 4, wherein said fuel type is selected to achieve substantial correspondence between the relationship for said retail fuel site and the relationship for the selected fuel type.

6. A computer-implemented method according to claim 1, further comprising determining, by the processor, said data indicating a relationship between fuel price and fuel sales for each of said plurality of fuel types.

7. A computer-implemented method according to claim 6, wherein said determining comprises, for each of said plurality of fuel types:
receiving, as input to the processor, historical data for said fuel type; and
processing, by the processor, said historical data to determine said relationship for said fuel type.

8. A computer-implemented method according to claim 7, wherein processing said historical data to determine said relationship for said fuel type comprises evaluating, by the processor, a Bayesian hierarchical model with respect to said historical data.

9. A computer-implemented method according to claim 1, wherein each of said fuel types is a fuel brand.

10. A computer readable medium carrying a computer program comprising computer readable instructions configured to cause a computer to carry out a method according to claim 1.

11. A computer apparatus for selecting a fuel type for a retail fuel site, the apparatus comprising:
a memory storing processor readable instructions; and
a processor arranged to read and execute instructions stored in said memory;
wherein said processor readable instructions comprise instructions arranged to control the computer to carry out a method according to claim 1.

12. A computer-implemented method of generating fuel price data for a retail fuel site, the method being implemented in a computer comprising a memory in communication with a processor, the method comprising:
receiving, as input to the processor, data indicating a relationship between the retail fuel site and each of a plurality of competitor retail fuel sites;
processing, by the processor, the received data to select at least one competitor retail fuel site of the plurality of competitor retail fuel sites; and
receiving, as input to the processor, fuel price data for the selected at least one competitor retail fuel site; and
generating, by the processor, said fuel price data for the retail fuel site based upon the received fuel price data for the selected at least one competitor retail fuel site.

13. A computer-implemented method according to claim 12, wherein said data indicating a relationship between the retail fuel site and each of a plurality of competitor retail fuel sites indicates, for each of said competitor retail fuel sites, a relationship between fuel price at said competitor retail fuel site and sales at said retail fuel site.

14. A computer-implemented method according to claim 12, wherein processing the received data comprises determining, by the processor, a competitor retail fuel site for which said relationship between the retail fuel site is strongest.

15. A computer-implemented method according to claim 12, further comprising generating, by the processor, said data indicating a relationship between the retail fuel site and each of said plurality of competitor retail fuel sites.

16. A computer-implemented method according to claim 15, wherein generating said data comprises for each of said competitor retail fuel sites:
receiving, as input to the processor, historical data for said retail fuel site and said competitor retail fuel site; and
processing, by the processor, said historical data to determine said relationship for said competitor retail fuel site.

17. A computer-implemented method according to claim 16, wherein processing said historical data to determine said relationship comprises evaluating, by the processor, a Bayesian hierarchical model with respect to said historical data.

18. A computer-implemented method according to claim 12, wherein generating said fuel price data comprises:
performing, by the processor, an optimisation operation, said optimisation operation having a price differential with respect to said selected competitor retail fuel site as a constraint.

19. A computer readable medium carrying a computer program comprising computer readable instructions configured to cause a computer to carry out a method according to claim 12.

20. A computer apparatus for generating fuel price data for a retail fuel site, the apparatus comprising:
a memory storing processor readable instructions; and
a processor arranged to read and execute instructions stored in said memory;
wherein said processor readable instructions comprise instructions arranged to control the computer to carry out a method according to claim 12.
